(19) United States
(12) Patent Application Publication
(10) Pub. No.: US 2025/0094920 A1
(43) Pub. Date: Mar. 20, 2025

(54) PERSONALIZED SHIPPING LABELS WITH CUSTOMIZABLE CONTENT

(71) Applicant: Walmart Apollo, LLC, Bentonville, AR (US)

(72) Inventors: Varshit Gupta, Sunnyvale, CA (US); Nir Rostoker, Redmond, WA (US)

(21) Appl. No.: 18/828,898

(22) Filed: Sep. 9, 2024

Related U.S. Application Data
(60) Provisional application No. 63/583,734, filed on Sep. 19, 2023.

(51) Int. Cl. G06Q 10/083; G06F 16/9535; G06K 7/14; G06T 11/00

(52) U.S. Cl. CPC G06Q 10/0838; G06F 16/9535; G06K 7/1417; G06T 11/00

(57) ABSTRACT

Examples provide personalized shipping labels with dynamically customized content. Package-related data associated with an item to be shipped to a user is obtained from one or more data sources. The package-related data is analyzed with ambient data using a set of rules. Customized content predicted to be of interest to the user is generated. The customized content includes content printed on available space in the shipping label and/or dynamically customized content linked to a customized content code, such as a quick response (QR) code printed on the label within carrier-specific available space on the label. The dynamically customized content is updated in real-time in response to updates in the package-related data, such as changing events, the recipient's location, and/or the user scanning the code. The content linked to the content code can updated during package transit before the package is delivered or after receipt of the package by the recipient.

### BACKGROUND

Shipping labels are used on the exterior of packages for routing the packages to a delivery destination. Typically, shipping labels have a generic and static design. The labels are usually plain paper labels printed with dark text over white backgrounds providing information associated with the sender of the package, the intended recipient, and the carrier delivering the package to the intended destination. However, labels typically also include significant portions of empty space which are currently unused, resulting in inefficient utilization of resources.

### SUMMARY

Some examples provide a system for generating dynamically customized content associated with personalized shipping labels. The system obtains package-related data associated with an item to be shipped to a user from one or more data sources. The package-related data includes data associated with the package, such as, but not limited to, recipient information associated with the intended recipient of the package and/or a carrier identification (ID) associated with a carrier shipping or otherwise transporting the item from a supplier to a recipient. The package-related data is analyzed using a set of one or more rules. Customized content predicted to be of interest to the intended recipient is generated based on a result of analysis of the package-related data. Carrier-specific customizable space within a shipping label is identified using the carrier ID. The customized content is printed within the customizable space of the shipping label prior to shipping the item to the user.

Other examples provide a method for generating dynamically customized content associated with personalized shipping labels. A label manager analyzes package-related data associated with an item to be shipped to an intended recipient using a set of rules. The package-related data includes a carrier identification (ID) associated with a carrier shipping the item to the intended recipient. The label manager generates customized content predicted to be of interest to the intended recipient based on a result of analysis of the package-related data. The label generator identifies per-carrier customizable space within a shipping label associated with the carrier ID available for personalization. The label manager sends an instruction to print a customized content code within the per-carrier customizable space, wherein the customized content is linked to the customized content code. The customized content is output to the user in response to the user scanning the customized content code. The customized content is dynamically updatable during package transit in response to events occurring during transit of the package to the intended recipient.

Still other examples provide a computer storage device having computer-executable instructions stored thereon. When executed by a computer, the instructions cause the computer to perform operations including analyzing package-related data associated with an item to be shipped to a user using a set of rules; generating customized content predicted to be of interest to the user based on a result of analysis of the package-related data; and identifying per-carrier customizable space within a shipping label associated with the carrier ID available for personalization. The customized content is printed within the customizable space of the shipping label affixed to the package prior to shipping to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for generating personalized shipping labels with customized content.

FIG. 2 is an exemplary block diagram illustrating a system for generating content customized for each user in a plurality of users.

FIG. 3 is an exemplary block diagram illustrating a system for dynamically generating customized content for output to users in response to scanning personalized shipping label code.

FIG. 4 is an exemplary block diagram illustrating a label manager generating dynamically updated customized content in response to changing events in real-time.

FIG. 5 is an exemplary block diagram illustrating a label manager for generating dynamically customized content for personalized shipping labels.

FIG. 6 is an exemplary block diagram illustrating a personalized shipping label including customized content.

FIG. 7 is an exemplary personalized shipping label having customized content including a promotion predicted to be of interest to a user receiving a package having the personalized shipping label affixed thereto.

FIG. 8 is an exemplary personalized shipping label having customized content predicted to be of interest to a user receiving a package having the personalized shipping label affixed thereto.

FIG. 9 is an exemplary personalized shipping label having customized content including a background design predicted to be of interest to a user receiving a package having the personalized shipping label affixed thereto.

FIG. 10 is an exemplary block diagram illustrating a system architecture associated with generation of customized content for personalized shipping labels.

FIG. 11 is an exemplary block diagram illustrating a system architecture associated with generation of dynamically customized content output to a user scanning a code on a personalized shipping label.

FIG. 12 is an exemplary flow chart illustrating operation of the computing device to generate personalized shipping labels including customized content.

FIG. 13 is an exemplary flow chart illustrating operation of the computing device to generate personalized shipping labels including static and dynamic customized content.

FIG. 14 is an exemplary flow chart illustrating operation of the computing device to generate instructions for populating available customizable space within a shipping label with customized content.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Referring to the figures, examples of the disclosure enable personalized shipping labels with customizable content which is updateable in real-time. In some examples, a label manager analyzes package-related data, including the contents of a package and user-specific data associated with the recipient of the package, to generate customized content for the recipient of the package. The customized content is printed in available empty space(s) on the label. The customized content includes images, colors, designs, text, and other markings printed on the unused spaces available on shipping labels. The customized content optionally includes promotional information providing the user with targeted product information, discounts, offers, coupons, rewards, or other content predicted to be of interest to the recipient of the package to which the label is attached. This maximizes usage of available space on shipping labels while maximizing revenue. The customized content further improves user efficiency by providing customers with information and other content likely to be useful and/or desirable to the user.

Aspects of the disclosure further enable provision of dynamically customizable content via a customized content code printed on shipping labels, such as, but not limited to, a quick response (QR) code. When scanned, the code links a user device associated with a recipient of the package to dynamically customizable content likely to be of interest to the recipient. The customized content is updatable in real-time based on when the code is scanned, who scans the code, where the code is scanned and current events. This enables customized content to be changed, updated, and modified in real-time to better provide up-to-date and desirable content to the customer.

Other examples provide a label manager that determines content likely to be of interest to the customer based on package-related data obtained from a plurality of data sources, which is printed within available space on package labels. Customized content that is desirable to the user improves customer satisfaction and good-will. Likewise, content which is undesirable to users can be annoying to customers and erode good-will. Providing content likely to be of interest to the customer on package labels increases customer good-will and potentially encourages customer loyalty while providing promotional offers which are most likely to be utilized by customers for improved marketing and sales efficiency by merchants and/or suppliers.

The system further system reduces resources spent creating additional promotional content on existing labels or by adding additional labels for promotional content which is likely to be unwanted by customers or ignored by the customer, thereby increasing time and costs expended on generating label content which is unlikely to be beneficial to customers, suppliers, and/or merchants.

In other embodiments, the system identifies available space on different types of labels for use in adding additional customized content and/or a customized content code linked to dynamically updatable content available by scanning the code. This maximizes usage of all available space on package labels and improves the return on investment associated with providing customized labels at little to no additional expense. In this manner, the label-related resource usage associated with providing customized individual labels is optimized while further minimizing costs associated with generating and providing promotional content to users.

The computing device including the label manager operates in an unconventional manner by identifying carrier-specific available space on shipping labels and predicting what content is likely to be of interest to the user for inclusion on the printed label or presentation to the user upon scanning a code on the label to maximize usage of available space on packages while reducing ineffective or undesirable content provided to users. The system converts an ordinary shipping label to a dynamically customized label providing updateable content to users via a webpage linked to the QR code. This enables provision of content which can be updated and/or modified in real-time without reprinting labels. Moreover, content can be updated in real-time in response to events occurring during transit from the supplier to the intended recipient. In other words, customized content can be updated during transit after the package has shipped from the supplier/point of origin and before it has arrived/been received by the intended recipient. In this manner, the computing device is used in an unconventional way and allows customized content to be updated as a package is in transit as well as after the package has been delivered, thereby improving the functionality of the underlying computing device by reducing system resource usage, improving promotional offer acceptance by customers to further increase revenue, providing content that is responsive to real-time events occurring during transit, and minimizing costs associated with providing customizing content for each customer by modifying existing package labels.

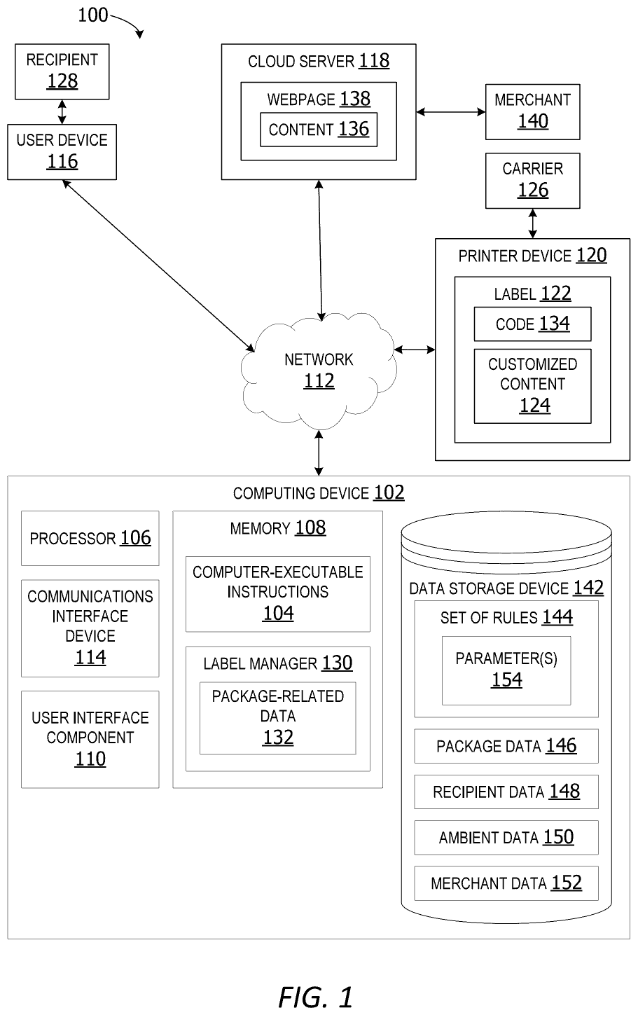

Referring again to FIG. 1, an exemplary block diagram illustrates a system 100 for generating personalized shipping labels with customized content. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface component 110.

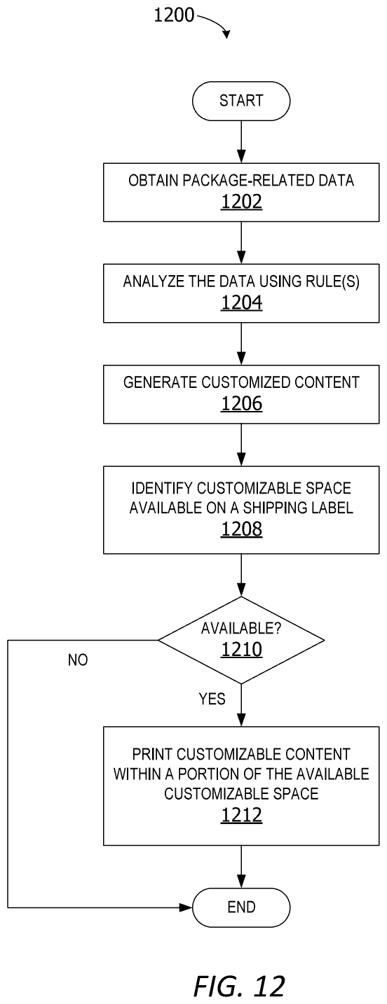

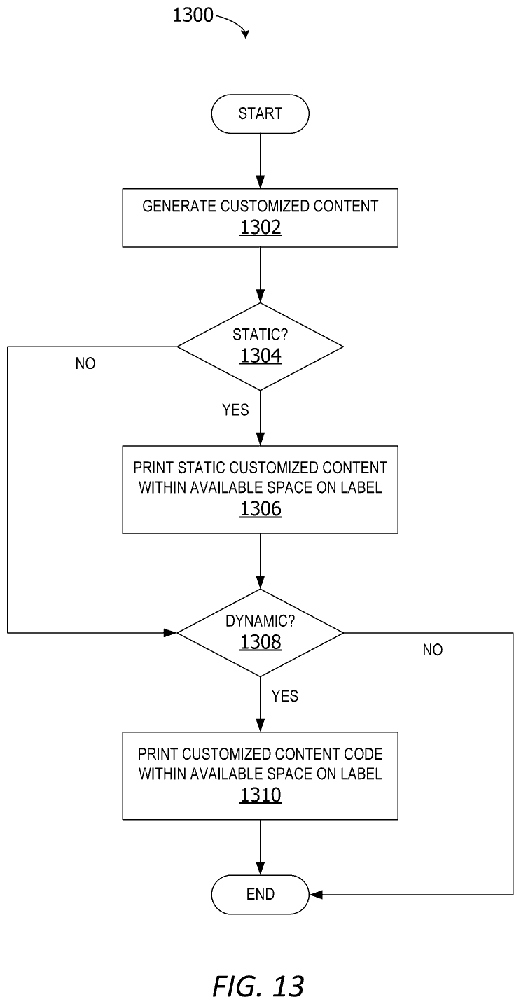

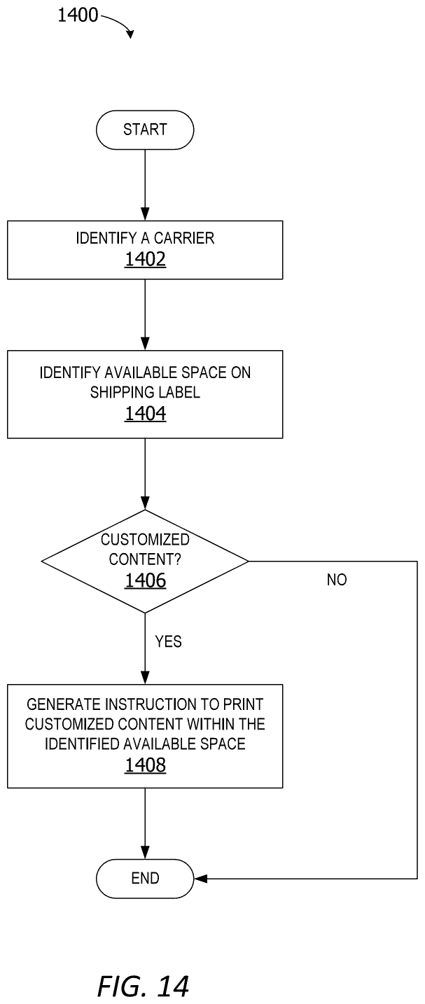

The processor 106 includes any quantity of processing units and is programmed to execute the computer-executable instructions 104. The computer-executable instructions 104 is performed by the processor 106, performed by multiple processors within the computing device 102 or performed by a processor external to the computing device 102. In some examples, the processor 106 is programmed to execute instructions such as those illustrated in the figures (e.g., FIG. 12, FIG. 13, and FIG. 14).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown).

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface component 110 includes a graphics card for displaying data to the user and receiving data from the user. The user interface component 110 can also include computer-executable instructions (e.g., a driver) for operating the graphics card. Further, the user interface component 110 can include a display (e.g., a touch screen display or natural user interface) and/or computer-executable instructions (e.g., a driver) for operating the display. The user interface component 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface component 114. The communications interface component 114 includes a network interface card and/or computer-executable instructions (e.g., a driver) for operating the network interface card. Communication between the computing device 102 and other devices, such as but not limited to a user device 116, a cloud server 118 and/or a printer device 120, can occur using any protocol or mechanism over any wired or wireless connection. In some examples, the communications interface component 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface component.

The cloud server 118 is a logical server providing services to the computing device 102 or other clients, such as, but not limited to, the user device 120. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The printer device 120 is any type of device configured to print shipping labels, such as, but not limited to, the personalized shipping label 122. The printer device 120 is a network-enabled printer receiving printing instructions for printing dynamically customized content 124 within available space on shipping labels, such as the personalized shipping label 122 in this example. The printer device 120 is connected to the network via any type of wired or wireless connection. In this example, the printer device 120 is associated with a carrier 126 shipping a package having the personalized shipping label 122 affixed to it.

The customized content 124 is any type of content customized for a recipient 128 of the package having the personalized shipping label 122. Customized content includes content which is selected for a specific recipient based on the recipient's interests, behavior, likes, dislikes, etc. Customized content can also include content that is customized based on seasonality, events, holidays, weather, or other ambient data associated with real-time conditions.

The customized content 124, in some embodiments, includes customized colors, images, designs, pictures, borders, promotions, or any other type of customized content predicted to be of interest to the recipient. In some examples, the customized content can include background colors, images, borders, and/or other designs. For example, if a customer frequently purchases items in blue, the system may print a blue background on the label. In another example, during the Christmas season, the customized content may include the colors green and red printed as a background or border around the edges of the label. Likewise, at Halloween, the label may include the colors black and orange.

In some embodiments, the customized content includes customized content in the foreground. In other examples, the customized content optionally also includes both customized content elements in the background as well as customized content elements in the foreground.

The customized content 124, in some examples, includes static content elements printed directly onto one or more portions of the personalized shipping label 122. The static content elements are customized dynamically by a label manager using real-time package-related data 132 obtained as an item is being prepared for shipping by the carrier 126 to the recipient 128. However, once printed on the label 122, the static customized content elements printed on the label remain unaltered. Thus, static content elements printed on the label remains unchanged after shipping and during transit.

In other examples, the customized content 124 includes dynamic content elements provided via an online source, such as a cloud server, web server, etc. the dynamic content is provided within a webpage linked to a customized content code 134 in some embodiments. In other embodiments, the dynamic content is pushed to the user from a server or other source to a user device for presentation to the user via a user interface. In this example, an application on the user device accesses an application programming interface (API) to connect to the server and obtain the content linked to the dynamic content code on the label. The customized content code 134 is any type of scannable code, such as, but not limited to, a quick response (QR) code, a matrix barcode, or any other type of code.

In some embodiments, a recipient 128 or other authorized user scans the customized content code 134 using a scanning device, such as, but not limited to, the user device 116. In this example, the user device 116 includes a scanning application which enables the user device 116 to generate scan data associated with the customized content code 134. In other embodiments, the user/recipient scans the code by capturing an image of the customized content code 134 via an image capture device on a user device, such as a camera. Scan data is obtained from the image of the code. In this example, an application on the user device utilizes the image of the customized content code 134 to retrieve customized content generated for the recipient by the label manager.

In some embodiments, the scan data is transmitted to a computing device or cloud server hosting the dynamic customized content 136 having the dynamic content elements. The cloud server 118 presents a webpage 138 or other portal page having the dynamic customized content 136 to the recipient or other user via the network 112. In some examples, the webpage 138, including the customized content 136 is displayed via a display device or other output device of the user device 116. In this example, the webpage 138 is a webpage associated with a merchant 140 providing one or more promotional offers associated with the customized content 136. However, in other examples, the webpage 138 is associated with a supplier, a carrier, a third party or other entity.

The system 100 can optionally include a data storage device 142 for storing data, such as, but not limited to a set of rules 144, package data 146, recipient data 148, ambient data 150, and/or merchant data 152. The set of rules 144 includes one or more parameter(s) 154 for identifying content suitable for customization for a given recipient or another user. In some examples, the set of rules 144 includes a threshold time-period for including an offer or other promotion within customized content. For example, the threshold time-period can specify that an offer or discount should not be included in customized content if the offer or discount expires within twenty-four hours or less. This prevents the recipient from receiving a package including customized content with an offer that has already expired or is about to expire in a very short period of time which might lead to frustration or disappointment for the recipient 128.

In another example, the set of rules 144 includes a parameter specifying that customized content including a promotion which can only be used or at a specific location is restricted based on distance or other geographic factors. For example, if the customized content includes a promotional discount on theater tickets, the offer should only be provided to recipients within a threshold maximum distance from the theater associated with the promotional discount.

The package data 146 includes data describing the package intended for the personalized shipping label 122. The package data 146, in some examples, includes an identification of the contents of the package, package weight, package size (dimensions), etc. The package contents include each item shipped within the package. In some examples, an item may be shipped without packaging. In such cases, the package data 146 describes the item. In this example, the label 122 may be affixed directly onto the item.

The recipient data 148 is data describing the recipient 128. The recipient data 148, in some examples, includes the recipient's preferences, behavior, interests, hobbies, transaction history (previous items purchased), name, address, profile data, as well as any other user-related data. The recipient data 148 in other examples includes user-provided data, such as user responses to a survey, user settings in a user account, etc.

The ambient data 150 is real-time data associated with the recipient 128, such as location data associated with the pickup/delivery location of the package and/or the recipient, events, etc. The real-time location of the recipient includes the recipient's address/residence, shipping address, and/or pickup location for a package to be picked up by the recipient. The ambient data 150 includes data associated with events and conditions associated with the recipient's location and the area/vicinity of the recipient's locations, such as local weather at the location, local events at or near the recipient's location, etc. The real-time location data can be obtained from news websites, websites detailing local city and county events, etc.

The ambient data 150, in some examples, includes data describing events, such as parades, holidays, sporting events, news items, local/regional events, etc., associated with the shipping address. The ambient data 150 in some other examples includes seasonal information, weather information, and any other real-time ambient information associated with the shipping address.

The merchant data 152 is data associated with the merchant 140 providing the item purchased by the recipient and/or promotion(s) included in the customized content. The merchant data 152, in some examples, includes a merchant identifier (ID), merchant address, promotional offers, sales, discounts, rebates or other sales information associated with the merchant.

The data storage device 142 can include one or more different types of data storage devices, such as, for example, one or more rotating disks drives, one or more solid state drives (SSDs), and/or any other type of data storage device. The data storage device 142 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 142 includes a database.

The data storage device 142 in this example is included within the computing device 102, attached to the computing device, plugged into the computing device, or otherwise associated with the computing device 102. In other examples, the data storage device 142 includes a remote data storage accessed by the computing device via the network 112, such as a remote data storage device, a data storage in a remote data center, or a cloud storage.

The memory 108, in some examples, stores one or more computer-executable components. Exemplary components include the label manager 130. In some examples, the label manager 130, when executed by the processor 106 of the computing device 102, obtains package-related data 132 from a plurality of data sources, such as, but not limited to, the cloud server 118 and/or the data storage device 142. The package-related data 132 includes data such as, but not limited to, the package data 146, the recipient data 148, and/or the merchant data 152. The label manager 130 analyzes the package-related data 132 and the ambient data 150 with the set of rules 144 to generate customized content predicted to be of interest to the recipient 128. The label manager 130 identifies per-carrier customizable space within the shipping label 122 associated with the carrier 126 available for personalization.

The ambient data 150 is data obtained from one or more sources, such as online data sources. These data sources can include internal and/or external sources. The sources of ambient data include sources of news, weather, events, etc. These sources can include, for example, but without limitation, the national weather service, the associated press (AP) services, local news websites, and/or any other public or private sources of ambient data. The ambient data is obtained via wired and/or wireless networks.

The ambient data can be updated in real-time as new information regarding ambient conditions is obtained. For example, if ambient data indicates a weather forecast for three days of rain, the system may consider including promotional offers for rain gear in the customized content. However, if an updated weather forecast (updated ambient data) is received indicating the rain did not occur or has been delayed, the system may update the customized content to remove the promotional offers associated with rain gear and instead include other offers or content.

The updated ambient data is obtained, in some examples, by the label manager 130 pulling ambient data from the one or more sources of ambient data available via the network. In other examples, the label manager pulls the updated ambient data at the occurrence of a predetermined event, such as a time-interval passing, a date, time, or other event. In one example, the system checks for updated ambient data at or near the expected time of package delivery to the recipient. In this example, if the package is expected to be delivered in twenty-four hours, the system checks for updates of ambient data in twenty-three hours. In other examples, if the package is scheduled to be delivered in forty-eight hours, the system checks for updates to the ambient data in approximately forty-eight hours.

In some examples, the label manager 130 identifies the carrier 126 using a carrier ID or other carrier identifying data obtained from the package-related data. The carrier ID is obtained from the package data 146. The carrier may be selected by the package recipient, the supplier/vendor, and/or the merchant. The carrier ID is used to retrieve a label template for the carrier. In some examples, a label template associated with each carrier is stored locally on the data storage device 142. In other examples, the label template for each carrier is obtained from the selected carrier associated with the carrier ID. In still other examples, label templates for one or more carriers are stored in a remote data store, which is accessed via the network 122. In some examples, the label template includes an identification of unused space within the label which is available for customization.

In some examples, the customized content includes static content printed on the label 122 and/or a customized content code 134 printed on the label. The static customized content is content printed on the label which cannot be changed or altered after the package is shipped. The dynamic customized content can be updated, changed, or altered after the package is shipped until the user scans the customized content code 134.

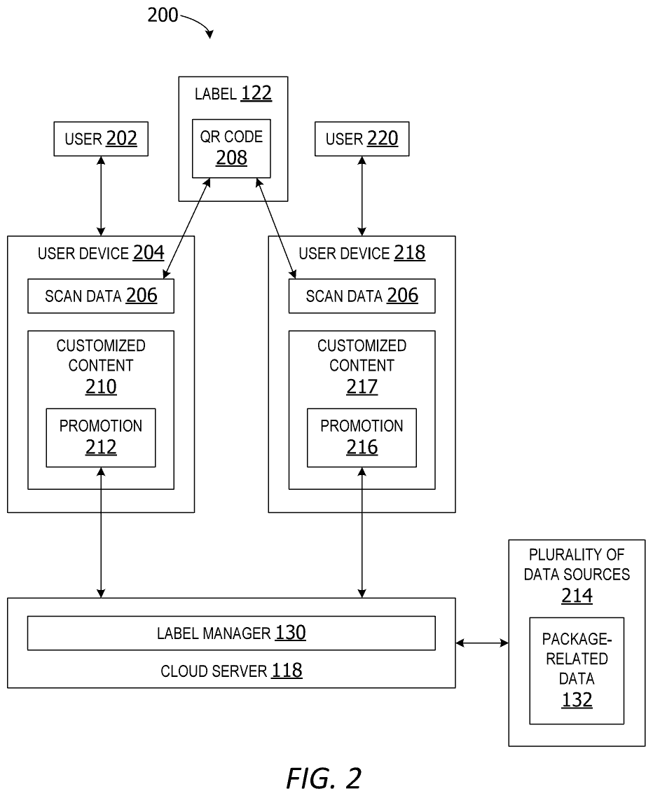

In some embodiments, the customized content code 134 is a QR code, such as, but not limited to, the QR code 208 in FIG. 2 below. In these examples, the user scans the QR code and views the customized content linked to the QR code via an application on the user device and/or via a web browser displaying a web page having content customized for the user. However, the embodiments are not limited to a QR code. In other embodiments, the customized content code 134 includes a universal product code (UPC), matrix barcode, or any other type of code.

The customized content code 134 links to the dynamic customized content when scanned by the user device 116 or another scanner device. Examples of static content include a border, a background color, a promotional offer printed within available space on the label, an image printed on the available space on the label, etc. The image can include any type of image predicted to be of interest to the customer.

For example, if the user enjoys golf, the static content might include a background of printed golf clubs. In another examples, if the user likes cartoon characters, a cartoon character of interest to the user can be printed on the label as static content. Once printed, the static content cannot be changed without replacing the entire label. In contrast, dynamic content is linked to the QR code or other customized content code. The dynamic content, in some embodiments, is updated or changed as many times as desired. Thus, each time the QR code is scanned, different dynamic content can be served to the user scanning the QR code.

The label manager 130 generates the static customized content 124 printed directly on the label and/or the dynamic customized content 136 linked to the QR code. In this example, the label manager 130 pushes the dynamic customized content 136 to webpage 138. The user device 116 accesses the customized content via the webpage in response to the user device 116 scanning the QR code. In other examples, the label manager verifies the user is an authorized user prior to enabling the recipient to access the customized content.

In other examples, the label manager pushes the dynamic customized content directly to the user device scanning the QR code. In this example, the computing device hosting the label manager also functions as a web server or other content server pushing the dynamic customized content directly to the customer/user in response to the customer/user scanning the QR code.

The static customized content and QR code data, in some examples, is provided to a third-party generating the physical paper labels. The third-party generates the label(s) including the static customized content and/or QR code linked to dynamic customized content for utilization on packages. However, the examples are not limited to providing the data to a third-party. In other examples, the system generates instructions which are provided to one or more label printing devices. In these examples, the label manager optionally transmits one or more instructions to the printer device 120 instructing the printer device to print the customized content 124 and/or the customized content code within the per-carrier customizable space available within the label 122. The dynamic customized content 136 is output to the user in response to the user scanning the customized content code.

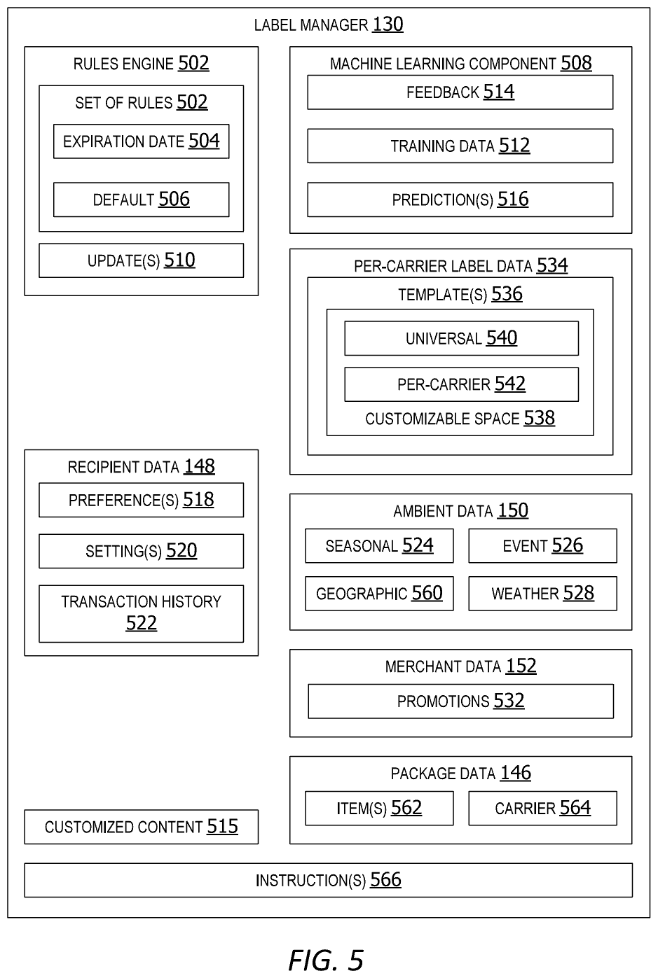

In some examples, the label manager includes a machine learning (ML) component, as shown in FIG. 5 below. The ML component generates the prediction(s) associated with identifying content likely to be of interest to the customer/recipient of the package. The ML may include pattern recognition, modeling, or other machine learning algorithms to analyze package-related data and/or other information to generate customized content predicted to be of interest to a specific recipient.

Thus, the label manager 130 generates unique content for each recipient based on the content of the package, as well as the real-time events occurring when the package is prepared for shipping, in the interim between shipping and delivery, and/or when the QR code on the label is scanned by the user. Moreover, the system automatically takes into account per-carrier differences in labels to determine where to print the customized content and/or the QR code. In other words, the label manager determines the per-carrier differences in the shipping labels to predict the most effective and efficient locations on the label for printing customized content and customized content codes.

In some embodiments, if the package is delayed in route, the system can dynamically update the customized content to change/update the promotion that is displayed to the recipient once the recipient scans the customized content code 134. This makes the system adaptable and flexible to changing events and situations, thereby improving the predicted value of the customized content for the recipient.

FIG. 2 is an exemplary block diagram illustrating a system 200 for generating content customized for each user in a plurality of users. The system 200 is a system for generating personalized shipping labels, such as, but not limited to, the system 100 in FIG. 1. The plurality of users can include two or more customers in the same household or residence. For example, a package may be directed to a recipient living at a residence. However, the QR code on the label could be scanned by the recipient or the recipient's spouse. In such cases, there are two possible users that might scan the QR code. In this example, the system generates different customized content for the recipient and other different content for the spouse, such that the content displayed to a user scanning the QR code changes depending on which member of the household scans the QR code.

The system determines an identity of a user scanning the QR code, in some examples, based on user credentials entered into an application or a login provided when the user attempts to access the content linked to the QR code. In other examples, the system determines the identity of the user when the user scans the QR code using an application on a mobile device which is associated with the user. The application optionally provides account information or other identifier associated with the user when the QR code is scanned.

In some examples, a first user 202 scans a customized content code using a first user device 204 to generate first scan data 206 associated with the customized content code. In this example, the customized content code is a QR code 208 printed on a personalized shipping label 122. The label manager 130 analyzes package-related data 132 obtained from a plurality of data sources 214. The plurality of data sources 214 includes one or more sources of package-related data, such as, but not limited to, the data storage device 142 in FIG. 1.

In some examples, the label manager 130 generates different customized content for each different user that scans the QR code or other customized content code. In this example, the label manager 130 generates first customized content 210 including a first promotion 212 for the first user 202. The first user 202 is identified using user credentials, such as, but not limited to, login data such as username and/or password. The user enters or provides credentials in some examples via an application which enables the user to gain access to the webpage hosting the customized content linked to the QR code.

In other examples, the label manager generates second customized content 217 including a different promotion 216 in response to receiving scan data 206 from the user device 218 associated with a second user 220. The label manager 130 generates different customized content with different promotions for each user.

The label manager 130 in this example is hosted on a cloud server 118. However, in other examples, the label manager is located on a computing device, such as, but not limited to, the computing device 102 and/or the user device 116 in FIG. 1.

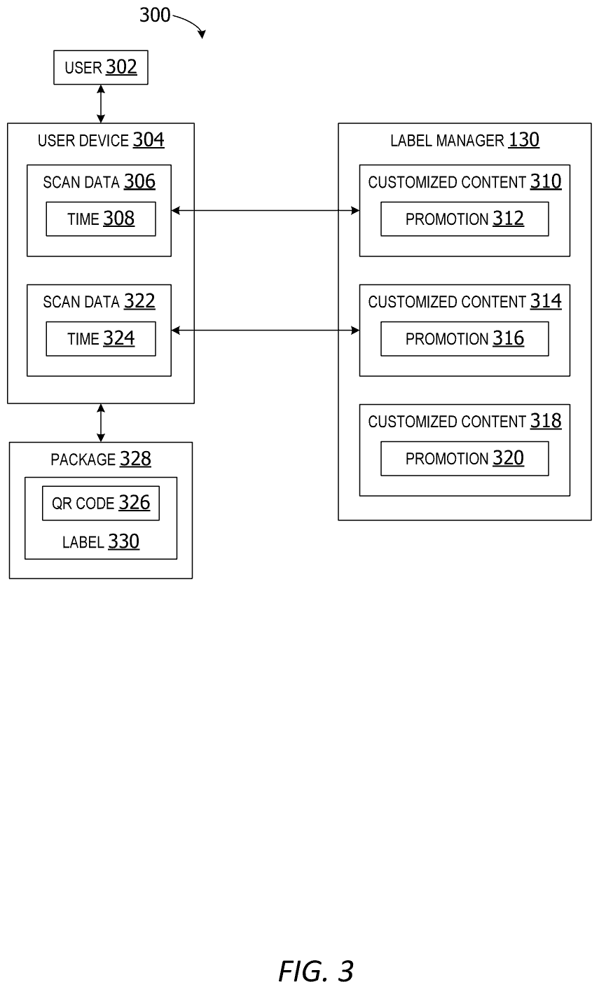

FIG. 3 is an exemplary block diagram illustrating a system 300 for dynamically generating customized content for output to users in response to scanning a personalized shipping label code. The system 300 is a system including a label manager, such as, but not limited to, the system 100 in FIG. 1 and/or the system 200 in FIG. 2.

In some examples, the label manager 130 generates different customized content each time the same user scans the customized content code. In other examples, the label manager 130 generates different customized content for each different user that scans the same customized content code, such as a QR code 326 printed on a package 328 label 330.

The user 302 associated with the user device 304 generates first scan data 306 at time 308. The label manager 130 in this examples generates a plurality of customized content outputs which are predicted to be of interest to the user. The plurality of customized content outputs includes a customized content 310 including a promotion 312, customized content 314 including a promotion 316 and customized content 318 including a promotion 320. The label manager 130 selects the customized content predicted to be of greatest interest to the user 302 based on the real-time ambient data and package-related data available to the label manager 130. In this example, the label manager 130 outputs the customized content 310 to the user 302 in response to the first scan of the customized content code.

In other examples, if the user 302 scans the same customized content code to generate second scan data 322 at a later time 324, the label manager 130 outputs different customized content to the user 302. In this manner, the system does not repeatedly output the same promotional offers to the same user multiple times. In this example, the label manager 130 outputs the dynamic customized content 314 in response to the second scan data 322. However, in other examples, the label manager 130 outputs the customized content 318 or generates new updated customized content in response to the second scan data. New updated customized content is generated if the package-related data and/or ambient data indicates a change or new event necessitating updating of the customized content.

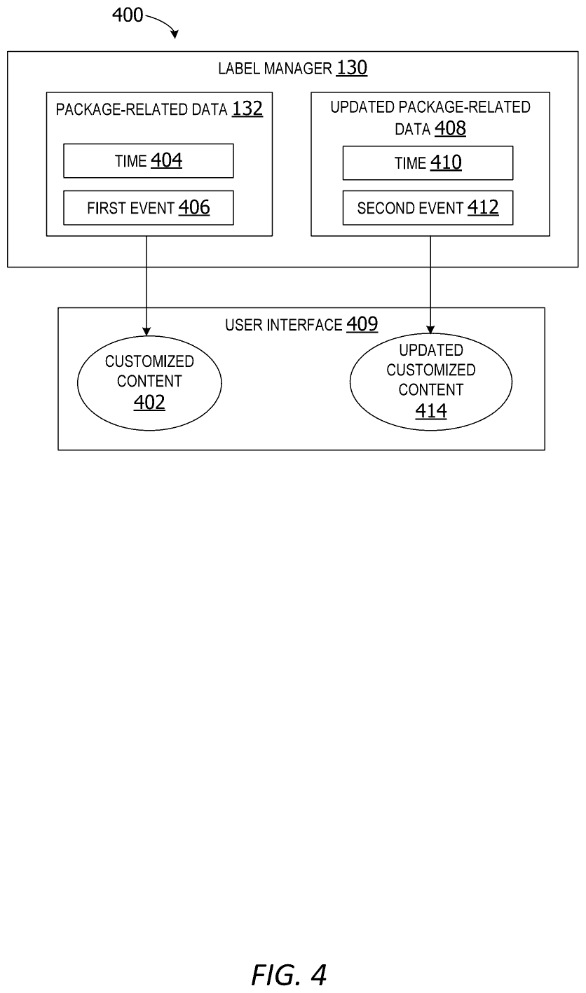

Referring now to FIG. 4, an exemplary block diagram illustrating a system 400 including a label manager 130 generating dynamically updated customized content in response to changing events in real-time is shown.

The label manager 130 updates dynamic customized content in real-time based on changing events and updated package-related data obtained while a package is in transit and/or prior to the recipient scanning the customized content code. In this example, the label manager 130 generates original customized content 402 for a user based on package-related data 132 obtained at a first time 404. When a user scans a QR code, the customized content 402 is presented to the user via a user interface 409. The user interface 409 is a user interface device, such as, but not limited to, the user interface component 110 in FIG. 1.

In this example, the package-related data 132 includes data associated with a first event 406. The event 406 describes any type of event, such as, but not limited to, an item purchased by a user, a sporting event, a holiday, or any other event. However, if the label manager 130 receives updated package-related data 408 at a later time 410 describing a new second event 412 prior to the user receiving the customized content 402, the label manager 130 generates updated customized content 414.

For example, if the second event 412 indicates the user has already purchased an item associated with a promotion offered in the customized content 402, the label manager updates the customized content to include a promotion for a different offer, as it is unlikely the user will want to purchase the same item again within a short period of time. When the user scans the same QR code, the updated customized content 414 is presented to the user via the user interface 409. This ensures the promotions offered with the customized content remain relevant to the user while reducing unwanted content pushed to the user.

FIG. 5 is an exemplary block diagram illustrating a label manager 130 for generating dynamically customized content for personalized shipping labels. In this example, the label manager 130 includes a rules engine 502 for managing and updating the set of rules 144 used to identify relevant promotions and other relevant content for the user. The set of rules 144 includes one or more parameters for identifying relevant promotions as well as filter(s) for eliminating irrelevant promotional material.

The set of rules 144 in some examples includes an expiration data 504 associated with one or more promotions. If the expiration date is reached, the promotion is filtered to remove it from future customized content. In other examples, the set of rules 144 includes default 506 content which can be included with customized content for selected users.

A machine learning component 508 is optionally included. The machine learning component 508 may include pattern recognition, modeling, or other machine learning algorithms to analyze data and/or database information to generate update(s) 510 to the set of rules 144 and/or the customized content.

In some examples, the machine learning component 508 includes one or more machine learning models trained using training data 512 and/or user feedback 514 to generate one or more prediction(s) 516 regarding content most likely to be of interest to a given user. The machine learning component 508 in some examples includes deep learning and/or natural language processing (NLP) models. In some examples, the machine learning optimizes over time, learning the customers behavior, AND preferences.

For example, the machine learning component 508 analyzes customer transaction data to determine which promotions are working and which promotions prove to have little interest for the customer based on whether the customer scanned the QR code and/or used the promotion. The machine learning also makes predictions based on purchase trends. For example, if the user begins buying pet-related items, such as a dog collar and dog treats, the machine learning predicts the customer owns a dog and might be interested in dog-related content.

The label manager takes in disparate data sources to obtain package-related data and applies the rule(s) and/or prediction algorithm to generate the prediction(s). ‘The label manager 130 analyzes package-related data, including recipient data 148, package data 146, merchant data 152 and/or ambient data 150 to generate customized content 515 predicted to be of interest to the recipient or other user scanning the customized content code and/or receiving the package.

In some examples, the system generates a score or ranking which is assigned to content predicted to be of interest to the user. The content having the highest score and/or the highest ranking is identified as content having the highest likelihood of being of interest to the user. In other words, the highest ranked/scored content is predicted to be of the greatest interest to the user. The content having the highest rank, or highest score is served to the user. The second highest ranked or the second highest scored content is served to the user after the highest ranked/scored content, and so forth.

The score and/or rank may be performed in any type of scoring or ranking system. For example, the score can include a percentage score, a number score, etc. The content may be ranked or scored based on application of one or more rules. The content may also be ranked/scored based on the user's transaction history/previous purchases, items searched on the merchant's app (search history), user-provided preferences, and other user-specific data.

The package data 146 is data describing a package and/or the contents of the package. In some examples, the package data 146 includes data describing one or more item(s) 562 inside the package and/or a carrier ID 564 associated with a carrier delivering the package to a delivery address associated with the recipient.

The recipient data 148 is data associated with the user receiving the package. In some examples, the recipient data 148 includes user preference(s) 518, user setting(s) 520 and/or transaction history 522. User preference(s) 518 include user likes, dislikes, hobbies, interests, etc. The user setting(s) 520 include user-provided settings, such as opt-in to receiving customized content, opt-out of receiving customized content, etc. The transaction history 522 is a history of prior purchases by the user, order history, prior use of discounts, previous offers and promotions utilized by the user, etc.

The ambient data 150 is data associated with real-time events and other dynamic data associated with the location and geographic area of the recipient. The ambient data 150 optionally includes seasonal 524 information identifying a season or time of year, events 526, weather 528 and/or geographic 560 information. For example, if weather 528 indicates a week of rainy weather, customized content may include promotions associated with rain gear. In another example, if geographic 530 information indicates the recipient lives near a beach, promotional offers and/or other customized content may include items associated with swimming and the beach. In yet another example, if seasonal information indicates it is spring, customized content may include images of flowers or other spring-related colors and imagery.

Merchant data 152 is data associated with the merchant providing the item being shipped to the recipient and/or the merchant providing the promotional offers included in the customized content. The promotions 532 include promotions from a single merchant as well as promotions from multiple different merchants. A promotion can be associated with an expiration date or other time period during which the promotional offer can be redeemed.

Per-carrier label data 534 is data associated with the one or more labels used by each carrier in a plurality of carriers delivering package(s) to recipient(s). The per-carrier label data 534 includes data describing the parts of the label(s) used by a given carrier, such as, but not limited to, one or more template(s) 536 for each carrier. A template 536 is a format, model, or form representing spaces within a label, such as, but not limited to, customizable space 538. The customizable space 538 is space which is available/unused space on the label which can be used for customizable content, such as static customizable content and/or the QR code. The customizable space 538 is space which is not needed for shipping data, such as the recipient data 148, the carrier data, the merchant data, shipping address, etc.

The customizable space 538 includes universal 540 space. Universal space 540 is space which is available on every label, regardless of the carrier. In other words, all the labels used by all carriers include the same un-used space in the same location. This un-used space in the same location is referred to as universal 540 space. The customizable space 538 includes per-carrier 542 customizable space. The per-carrier 542 space is space which is unique to a specific carrier. The per-carrier 542 customizable space placement on the label and dimensions of the available space are different for each carrier.

For example, a first carrier may have an open space that is two square inches in size and located on the left side of the label while a second carrier does not have any space available on the left side of the label. In this example, the two inch square space on the label of the first carrier is per-carrier customizable space unique to the first carrier. This space may be used for labels on packages delivered by the first carrier but may not be used on labels associated with packages for the second label. Likewise, if the universal 540 space includes a half inch border around the perimeter of the label, then the half inch border can be used for customization on labels used by any carrier.

In some examples, the label manager sends one or more instruction(s) 566 to a computing device instructing the device to print the customized content 515 within available customizable space associated with a shipping label via a network. The computing device is any type of device capable of printing a label, such as, but not limited to, the computing device 102 in FIG. 1 and/or the printer device 120 in FIG. 1. In other examples, the instruction(s) 566 include an instruction to print a customized content code, such as a QR code, on the label. The user scans the QR code to obtain access to dynamic customized content via the network. In other examples, the system sends the label data with the customized content generated based on the logic, rather than sending an instruction to print.

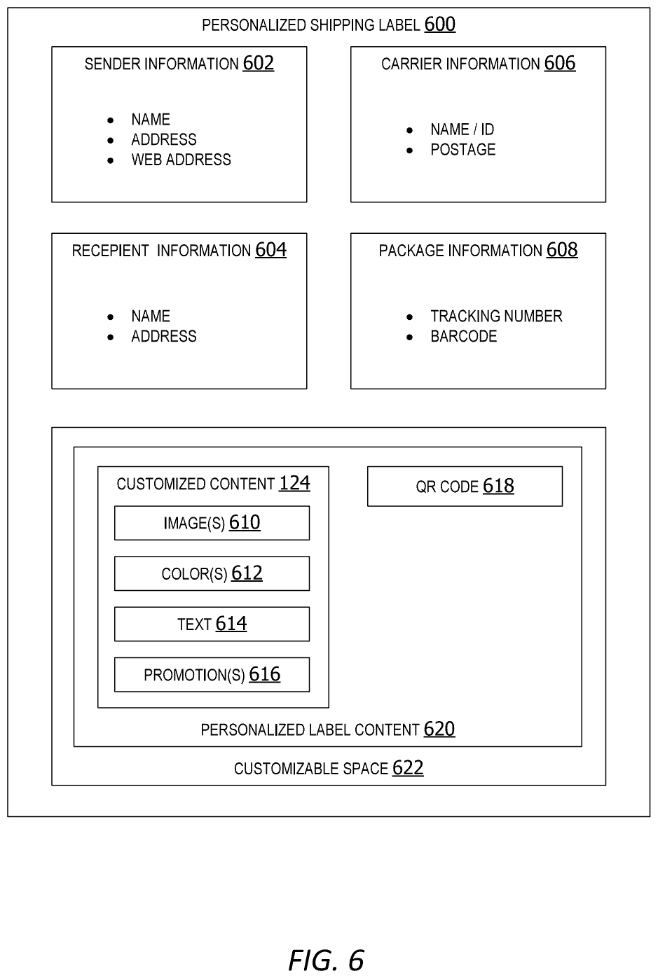

FIG. 6 is an exemplary block diagram illustrating a personalized shipping label 600 including personalized label content 620 printed within one or more portions of available customizable space 622 within the personalized shipping label 600. The personalized label content 620 includes customized content 124 and/or a QR code 618 linked to dynamic customized content. The personalized shipping label 600 is a label having customized content, such as, but not limited to, the shipping label 122 in FIG. 1. The personalized shipping label 600 includes sender information 602, recipient information 604, carrier information 606 and package information 608. The customized content 124 includes one or more image(s) 610, one or more color(s) 612, text 614, and/or promotion(s) 616.

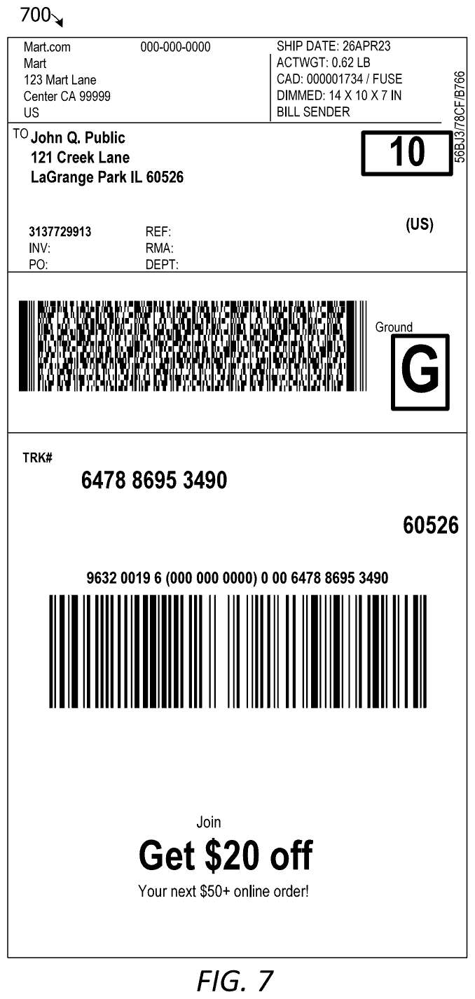

FIG. 7 is an exemplary personalized shipping label 700 having customized content including a promotion predicted to be of interest to a user receiving a package having the personalized shipping label affixed thereto. The personalized shipping label 700 is a label having personalized label content, such as, but not limited to, the label 122 in FIG. 1 and/or the label 600 in FIG. 6. In this example, the customized content includes a promotional offer for a twenty-dollar discount associated with a future purchase printed on a portion of the label.

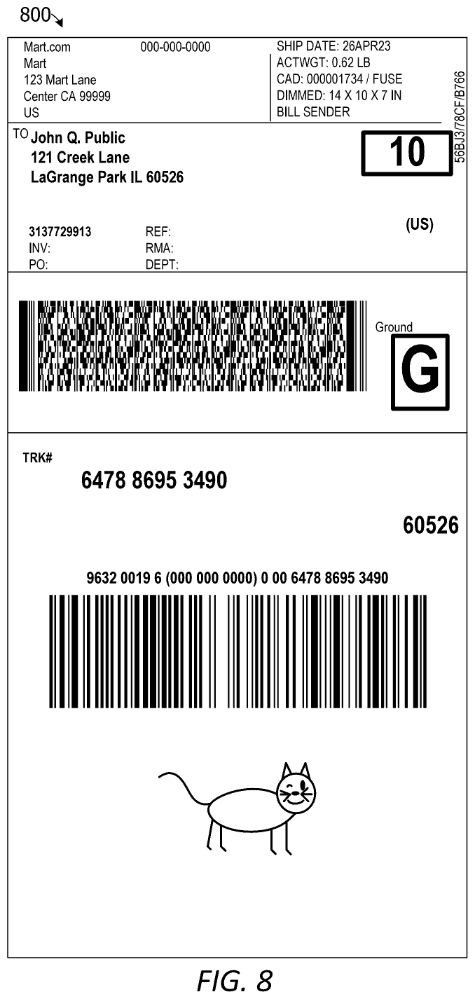

FIG. 8 is an exemplary personalized shipping label having customized content predicted to be of interest to a user receiving a package having the personalized shipping label affixed thereto. The personalized shipping label 800 is a label having personalized label content, such as, but not limited to, the label 122 in FIG. 1 and/or the label 600 in FIG. 6. In this example, the customized content includes a drawing of a cat in the foreground decorating a portion of the label.

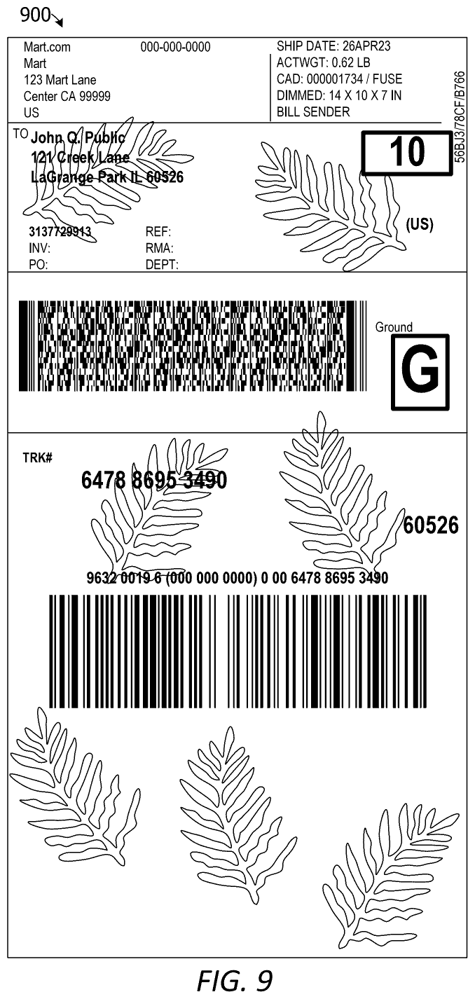

FIG. 9 is an exemplary personalized shipping label having customized content including a background design predicted to be of interest to a user receiving a package having the personalized shipping label affixed thereto. The personalized shipping label 900 is a label having personalized label content, such as, but not limited to, the label 122 in FIG. 1 and/or the label 600 in FIG. 6. In this example, the customized content includes a background design including leaves decorating the label.

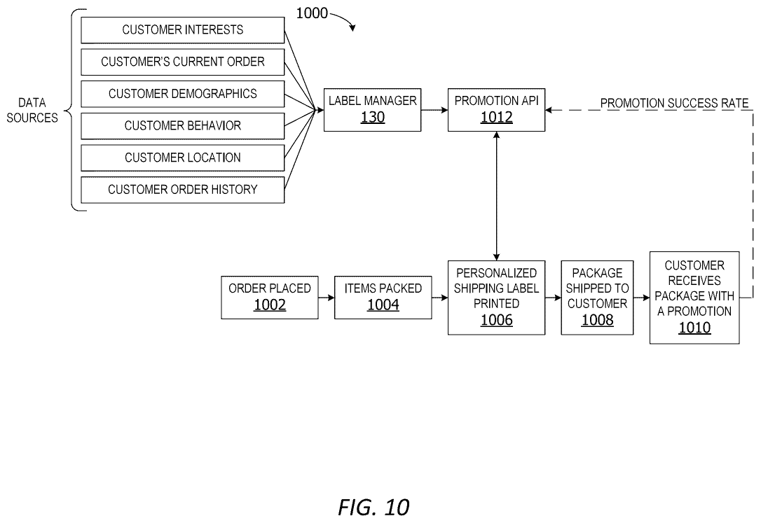

FIG. 10 is an exemplary block diagram illustrating a system architecture 1000 associated with generation of customized content for personalized shipping labels. In this example, the package-related data is obtained from a plurality of data sources by the label manager 130. The package-related data includes customer interests, current order information, customer demographics, customer behavior, customer location, and/or order history data. The package-related data is not limited to the types of data shown in FIG. 10. In other examples, the package-related data includes other data not shown in FIG. 10. For example, the package-related data can optionally include customer preferences, carrier data, package content data, etc.

In some examples, a user places an order at 1002. The ordered item(s) are packed into a package at 1004 for shipping. A personalized shipping label is printed at 1006. The package is shipped at 1008. The customer receives the package at 1010. Data associated with the success rate of any promotions included in the customized content printed on the personalized shipping label is transmitted to the label manager via a promotion application programming interface (API) at 1012.

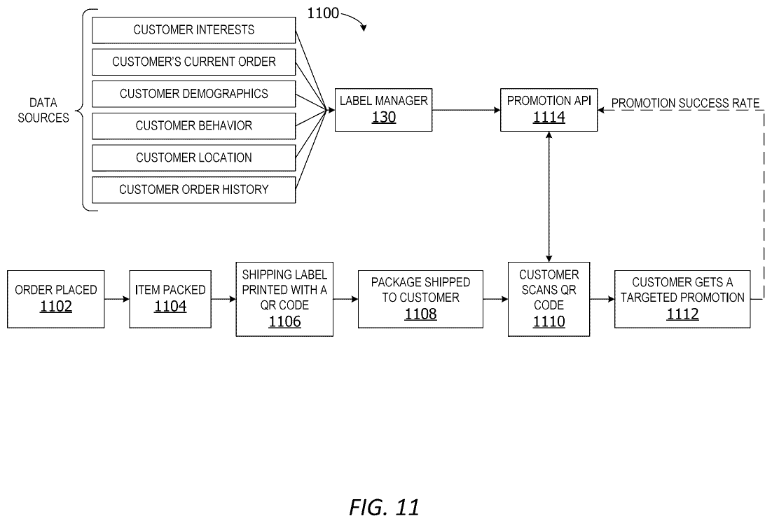

FIG. 11 is an exemplary block diagram illustrating a system architecture 1100 associated with generation of dynamically customized content output to a user scanning a code on a personalized shipping label. In this example, the label manager utilizes package-related data obtained from a plurality of data sources to generate dynamic customized content.

A user places an order at 1102. The item(s) in the order are packed into a package for shipping at 1104. A label including a customized content code, such as a QR code, is printed at 1106. The package with the personalized shipping label is shipped at 1108. The user scans the QR code at 1110. The user receives a promotion output to the user in response to scanning the QR code at 1112. The success rate of the promotion is transmitted to the label manager 130 via the API at 1114.

FIG. 12 is an exemplary flow chart 1200 illustrating operation of the computing device to generate personalized shipping labels including customized content. The process shown in FIG. 12 is performed by a label manager component, executing on a computing device, such as the computing device 102 and/or the user device 116 in FIG. 1.

The process begins with a label manager obtaining package-related data associated with an item ordered by a user at 1202. The label manager is a component for generating personalized shipping labels, such as, but not limited to, the label manager 130 in FIG. 1. A label manager analyzes the package-related data using a set of one or more rule(s) at 1204. The package-related data is data such as, but not limited to, the package-related data 132 in FIG. 1. The label manager generates customized content based on the results of the analysis of the package-related data at 1206. The label manager identifies customizable space available on a shipping label at 1208. A determination is made whether customizable space is available at 1210. If yes, the customizable content is printed within a portion of the available customizable space at 1212. The process terminates thereafter.

While the operations illustrated in FIG. 12 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 12.

FIG. 13 is an exemplary flow chart 1300 illustrating operation of the computing device to generate personalized shipping labels including static and dynamic customized content. The process shown in FIG. 13 is performed by a label manager component, executing on a computing device, such as the computing device 102 and/or the user device 116 in FIG. 1.

The process begins by generating customized content at 1302. A determination is made whether the customized content is static content at 1304. If yes, the static customized content is printed within available customizable space on the personalized shipping label at 1306. A determination is made whether the customized content includes dynamic customized content at 1308. If yes, a customized content code is printed within available customized space on the personalized shipping label at 1310. The process terminates thereafter.

While the operations illustrated in FIG. 13 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 13.

FIG. 14 is an exemplary flow chart 1400 illustrating operation of the computing device to generate instructions for populating available customizable space within a shipping label with customized content. The process shown in FIG. 14 is performed by a label manager component, executing on a computing device, such as the computing device 102 and/or the user device 116 in FIG. 1.

The process begins by identifying a carrier delivering a package to a recipient at 1402. The label manager identifies available customizable space on a shipping label at 1404. In some examples, the available space is identified using a carrier specific template. The template includes an identification of universal customizable space which is space available on all shipping labels regardless of the carrier. The template also optionally identifies carrier specific available space. A determination is made whether customized content is generated for the recipient at 1406. If yes, an instruction to print customized content within the identified available customizable space is generated at 1408. The instruction is transmitted to a printing device, such as the printer device 120 in FIG. 1. The process terminates thereafter.

While the operations illustrated in FIG. 14 are performed by a controller device or other computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 14.

### ADDITIONAL EXAMPLES

In some examples, the system provides personalized shipping labels with targeted promotions. Promotions in e-commerce can be costly. The system leverages empty space available on most shipping labels to provide targeted content customized for a particular user while decreasing the costs of providing e-commerce promotions. The label manager determines which content to place in which portion of the available space for a given label based on the size of the label, text layout, type of customized content, contents of the package, items purchased on the past, user preferences, etc. For example, if the package contains wash clothes, the system may determine that the user is likely to be interested in purchasing soap. If the user has purchased lavender scented products in the past, the system may determine that lavender scented soap is most likely to be of interest to the user. In such case, the system generates customized content including a promotion for lavender scented soap.

In other examples, the invention is directed to generating customized shipping labels for customers based on customer behavior, interests, geography, season, order history, contents of the package, etc. The label can be customized by customizing the label design (text, images, pictures, colors) and/or a QR code printed on the label that is linked to customized content. For example, a shipping box containing a sports team jersey may be printed with the team colors, include an offer or promotion for another sports related item, etc. The label can include designs associated with the contents of the box, the season, special occasions, interests of the customer, etc. The QR code on the label links to customized content, such as promotions, offers for items likely to be of interest to the user, recommended items, etc. The customized content can be different for each customer. An authentication can be required before access is granted to personalized content when scanning the QR code to protect customer privacy. The user can change settings to further customize the shipping labels.

In other examples, targeted promotions can be generated by using customer's browsing history, preferences, and other external parameters. Some examples of such parameters are the customer's purchase, browsing history, the customer's ad preferences, merchant driven promotions, seller driven promotions, seasons, festivals, sports-based promotions during the year and/or geography-based promotions.

Promotions are used to ensure that customers are aware of the existence and positioning of available products and services. Promotions are, however, often costly. Shipping labels are an untapped real estate for marketing in e-commerce, making them a great avenue for doing personalized promotions. These promotions can be print ads, label designs, coupon codes, etc.

In an example scenario, a customer that ordered a Golden State warrior jersey may receive a package with a blue-yellow colored label. In another example, a customer that orders toilet paper frequently may receive a subscription deal for future toilet paper orders by scanning a QR code on the label.

In one example, a customer gets directed to a personalized merchant deals page with numerous targeted deals by scanning a QR code on the label. In another example, a customer living in Denver may receive a package having a label with a printed ad for skis during the winter. Likewise, a kid who is a fan of superhero movies, may receive a package with a label having a printed ad for an upcoming superhero movie.

In an example scenario, a customer receives a package with toilet paper from a merchant with a QR code on the shipping label. The customer scans the QR code with his cellphone. The customer is routed to a personalized subscribe and save page for toilet paper products he frequently orders from the merchant.

In another example scenario, a customer gets a package with a superhero toy from a merchant. The shipping label has an ad for an upcoming superhero movie with a QR code that directs him to book the ticket in a cinema within his local area.

In some examples, a QR code-based promotions only display a promotion after the customer authenticates himself/herself. Therefore, non-authorized users will not be able to see another person's promotions. All non QR code-based promotions only use adequate information that can be publicly shared based on user preferences and merchant policies. Customers are able to opt out of these customized content promotions.

The promotion, in some examples, is a promotion for a product offered by the same merchant as the item in the package. In other examples, the customized content includes a promotion for a product which is offered by a different merchant or other third-party seller.

In some examples, the system does not print information which may be considered sensitive, personal, or private information on the label. This protects customer privacy and confidentiality.

The customized content can include text, such as text describing a promotion and/or text next to the QR code that says, “check me” or “scan for special offer.” The user scans the QR code using a mobile phone or other user device. This brings the user device to a landing page with the dynamically customized content, including one or more promotions. The customized content can include offers for subscriptions, related products, specials, coupons, deals, event tickets, etc. The customized content can also include still images, as well as video. For example, the customized content can include a trailer for a movie.

The customized content can include designs, such as holiday decorations printed on the label, sports-related images, etc. For example, if it is the user's birthday, the label may include images of wrapped gifts, a birthday cake, balloons, etc.

In some embodiments, the system receives event data associated with an event occurring after shipping a package having the shipping label from a source. The dynamic customized content is updated in response to the event data in real-time as the package is in transit from the source to an intended recipient. In other words, the customized content output to the user can be updated/changed after the package is shipped out from the supplier/source and before the package is received at the destination by the intended recipient. The updated dynamic customized content is linked to the customized content code. The updated dynamic customized content is output to the intended recipient in response to the intended recipient scanning the customized content code.

In other embodiments, updated event data associated with an event occurring after a package having the shipping label is received by an intended recipient is received. The updated event data can include any type of data, such as weather, purchases occurring after shipping, sporting events, or any other type of event. A second set of customized content is generated based on the updated event data. The dynamically customized content is updated with the second set of customized content. The second set of customized content is output to the intended recipient in response to the intended recipient scanning the customized content code.

Alternatively, or in addition to the other examples described herein, examples include any combination of the following:
wherein the customized content is static customized content;
wherein the static customized content includes a quick response (QR) code linked to dynamically customized content;
wherein the user scans the QR code on the shipping label to access a website storing the dynamically customized content;
wherein the dynamically customized content is first dynamically customized content;
receive updated event data describing an event occurring after shipping the package to a location associated with the user;
generate second dynamically customized content based on the updated event data;
wherein the user receives the second dynamically customized content in response to scanning the QR code after receipt of the package instead of the first dynamically customized content;
output the first dynamically customized content to the first user in response to the first user scanning the QR code of the shipping label;
output second dynamically customized content to a second user in response to the second user scanning the QR code of the shipping label, wherein the second dynamically customized content is different customized content than the first dynamically customized content;
output the first dynamically customized content to the user in response to the user scanning the QR code at a first time;
output second dynamically customized content to the user in response to the user scanning the QR code at a second time, wherein the first dynamically customized content is different customized content than the second dynamically customized content;
analyze the package-related data by a machine learning component;
generate a plurality of customized content predicted to be of interest to the user;
select customized content including a promotion having a highest predicted likelihood of being utilized by the user;
wherein the package-related data comprises merchant data, carrier data, recipient data, ambient data, and package data;
analyzing package-related data associated with an item to be shipped to a user using a set of rules, the package-related data including a carrier identification (ID) associated with a carrier shipping the item to the user;
generating customized content predicted to be of interest to the user based on a result of analysis of the package-related data;
identifying per-carrier customizable space within a shipping label associated with the carrier ID available for personalization;
sending an instruction to print a customized content code within the per-carrier customizable space, wherein the customized content is output to the user in response to the user scanning the customized content code;
wherein the customized content includes static customized content and dynamic customized content;
printing the static customized content within at least a portion of the per-carrier customizable space associated with the shipping label;
linking the dynamic customized content to the customized content code printed on the shipping label, wherein the dynamic customized content is output to the user in response to the user scanning the customized content code;
receiving updated event data describing an event occurring after shipping the package to a location associated with the user;
generating second dynamically customized content based on the updated event data, wherein the user receives the second dynamically customized content in response to scanning the QR code after receipt of the package instead of the first dynamically customized content;
presenting the first dynamically customized content to the first user in response to the first user scanning the QR code of the shipping label;
presenting second dynamically customized content to a second user in response to the second user scanning the QR code of the shipping label, wherein the second dynamically customized content is different customized content than the first dynamically customized content;
presenting the first dynamically customized content to the user in response to the user scanning the QR code at a first time;
presenting second dynamically customized content to the user in response to the user scanning the QR code at a second time, wherein the first dynamically customized content is different customized content than the second dynamically customized content;
analyzing the package-related data by a machine learning component;
generating a plurality of customized content predicted to be of interest to the user;
selecting customized content including a promotion having a highest predicted likelihood of being utilized by the user;
authenticating a user using credential associated with the user; and
providing access to the customized content linked to the customized content code in response to successful authentication of the user, wherein the user is denied access to the customized content in response to a failure to authenticate the user.

At least a portion of the functionality of the various elements in FIG. 1, FIG. 2, FIG. 3, FIG. 4, FIG. 5, FIG. 10 and FIG. 11 can be performed by other elements in FIG. 1, FIG. 2, FIG. 3, FIG. 4, FIG. 5, FIG. 10 and FIG. 11, or an entity (e.g., processor 106, web service, server, application program, computing device, etc.) not shown in FIG. 1, FIG. 2, FIG. 3, FIG. 4, FIG. 5, FIG. 10 and FIG. 11.

In some examples, the operations illustrated in FIG. 12, FIG. 13 and FIG. 14 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of providing personalized shipping labels, the method comprising analyzing package-related data associated with an item to be shipped to a user using a set of rules, the package-related data including a carrier identification (ID) associated with a carrier shipping the item to the user; generating customized content predicted to be of interest to the user based on a result of analysis of the package-related data; identifying per-carrier customizable space within a shipping label associated with the carrier ID available for personalization; and sending an instruction to print a customized content code within the per-carrier customizable space, wherein the customized content is output to the user in response to the user scanning the customized content code.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for personalized shipping labels with dynamically customized content. For example, the elements illustrated in FIG. 1, FIG. 2, FIG. 3, FIG. 4, FIG. 5, FIG. 10 and FIG. 11, such as when encoded to perform the operations illustrated in FIG. 12, FIG. 13 and FIG. 14, constitute exemplary means for analyzing package-related data associated with an item to be shipped to a user using a set of rules, the package-related data including a carrier identification (ID) associated with a carrier shipping the item in a package; constitute exemplary means for generating customized content predicted to be of interest to the user based on a result of analysis of the package-related data, the customized content comprising static customized content to be printed on the shipping label and a customized content code linked to dynamic customized content; and constitute exemplary means for identifying per-carrier customizable space within a shipping label associated with the carrier ID available for personalization, wherein the customized content is printed within the customizable space of the shipping label affixed to the package prior to shipping to the user.

Other non-limiting examples provide one or more computer storage devices having a first computer-executable instructions stored thereon for providing personalized shipping labels. When executed by a computer, the computer performs operations including obtaining package-related data associated with an item to be shipped to a user from a plurality of data sources; analyzing the package-related data using a set of rules, the package-related data comprising a carrier identification (ID) associated with a carrier shipping the item; generating customized content predicted to be of interest to the user based on a result of analysis of the package-related data; and identifying per-carrier customizable space within a shipping label associated with the carrier ID available for personalization, wherein the customized content is printed within the customizable space of the shipping label prior to shipping the item to the user.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for generating dynamically customized content associated with personalized shipping labels, the system comprising:
a processor; and
a computer-readable medium storing instructions that are operative upon execution by the processor to:
obtain package-related data associated with an item to be shipped to a user from a plurality of data sources;
applying a set of rules to the package-related data;
generate customized content predicted to be of interest to the user based on a result of application of the set of rules to the package-related data;
identify customizable space on a shipping label associated with a carrier ID of a carrier shipping the item; and
print the customized content within the customizable space of the shipping label prior to shipping the item to the user.

2. The system of claim 1, wherein the customized content includes a quick response (QR) code linked to the dynamically customized content, wherein the user scans the QR code on the shipping label to access a website storing the dynamically customized content.

3. The system of claim 2, wherein the dynamically customized content comprising a first set of customized content and wherein instructions are further operative to:
receive updated event data associated with an event occurring during package transit generate a second set of customized content based on the updated event data; and
update the dynamically customized content with the second set of customized content prior to receipt of the package by an intended recipient.

4. The system of claim 2, wherein the dynamically customized content is first dynamically customized content, wherein the user is a first user, and wherein instructions are further operative to:
output the first dynamically customized content to the first user in response to the first user scanning the QR code of the shipping label; and
output second dynamically customized content to a second user in response to the second user scanning the QR code of the shipping label, wherein the second dynamically customized content is different customized content than the first dynamically customized content.

5. The system of claim 1, wherein the dynamically customized content is first dynamically customized content, and wherein the instructions are further operative to:
output the first dynamically customized content to the user in response to the user scanning a QR code at a first time; and
output second dynamically customized content to the user in response to the user scanning the QR code at a second time, wherein the first dynamically customized content is different customized content than the second dynamically customized content.

6. The system of claim 1, wherein the instructions are further operative to:
analyze the package-related data by a machine learning component; and
predict a plurality of content of interest to the user based on the analysis; and
select the customized content from the predicted plurality of content, the selected customized content including a promotion having a highest predicted likelihood of being utilized by the user.

7. The system of claim 1, wherein the package-related data comprises merchant data, carrier data, recipient data, ambient data, and package data.

8. A method for generating dynamically customized content associated with personalized shipping labels, the method comprising:
analyzing package-related data associated with an item to be shipped to a user using a set of rules, the package-related data including a carrier identification (ID) associated with a carrier shipping the item to the user;
generating customized content predicted to be of interest to the user based on a result of analysis of the package-related data;
identifying customizable space of a shipping label associated with the carrier ID associated with the carrier shipping the item to the user;
printing the customized content code within at least a portion of the customizable space associated with the shipping label; and
linking the dynamic customized content to the customized content code printed on the shipping label, wherein the dynamic customized content is output to the user in response to the user scanning the customized content code.

9. The method of claim 8, further comprising:
receiving event data associated with an event occurring after shipping a package having the shipping label from a source;
updating the dynamic customized content in response to the event data in real-time as the package is in transit from the source to an intended recipient; and
linking the updated dynamic customized content to the customized content code, wherein the updated dynamic customized content is output to the intended recipient in response to the intended recipient scanning the customized content code.

10. The method of claim 9, wherein the dynamically customized content comprises a first set of customized content, and further comprising:
receiving updated event data associated with an event occurring after a package having the shipping label is received by an intended recipient;
generating a second set of customized content based on the updated event data; and
updating the dynamically customized content with the second set of customized content, wherein the second set of customized content is output to the intended recipient in response to the intended recipient scanning the customized content code.

11. The method of claim 9, wherein the dynamically customized content is first dynamically customized content, wherein the user is a first user, wherein the customized content code is a QR code, and further comprising:
presenting the first dynamically customized content to the first user in response to the first user scanning the QR code of the shipping label; and
presenting second dynamically customized content to a second user in response to the second user scanning the QR code of the shipping label, wherein the second dynamically customized content is different customized content than the first dynamically customized content.

12. The method of claim 9, wherein the dynamically customized content is first dynamically customized content, wherein the customized content code is a QR code, and further comprising:
presenting the first dynamically customized content to the user in response to the user scanning the QR code at a first time; and
presenting second dynamically customized content to the user in response to the user scanning the QR code at a second time, wherein the first dynamically customized content is different customized content than the second dynamically customized content.

13. The method of claim 8, further comprising:
analyzing the package-related data by a machine learning component; and
predict a plurality of content of interest to the user based on the analysis; and
select the customized content from the predicted plurality of content, the selected customized content including a promotion having a highest predicted likelihood of being utilized by the user.

14. The method of claim 8, further comprising:
authenticating the user using credential associated with the user; and
providing access to the customized content linked to the customized content code in response to successful authentication of the user, wherein the user is denied access to the customized content in response to a failure to authenticate the user.

15. One or more computer storage devices having computer-executable instructions stored thereon, which, upon execution by a computer, cause the computer to perform operations comprising:
analyzing package-related data associated with an item to be shipped to a user using a set of rules, the package-related data including a carrier identification (ID) associated with a carrier shipping the item in a package;
generating customized content predicted to be of interest to the user based on a result of analysis of the package-related data, the customized content comprising static customized content to be printed on a shipping label and a customized content code linked to dynamic customized content; and
identifying customizable space of the shipping label associated with the carrier ID associated with the carrier shipping the item in the package, wherein the customized content is printed within the customizable space of the shipping label affixed to the package prior to shipping to the user.

16. The one or more computer storage devices of claim 15, wherein the dynamically customized content comprises a first set of dynamically customized content, and wherein the operations further comprise:
receiving event data associated with an event occurring after shipping the package to a location associated with the user;
generating a second set of customized content based on updated event data; and
updating the dynamically customized content with the second set of customized content, wherein the user receives the updated dynamically customized content in response to scanning the customized content code after receipt of the package instead of the first dynamically customized content.

17. The one or more computer storage devices of claim 15, wherein the dynamically customized content is first dynamically customized content, wherein the user is a first user, and wherein the operations further comprise:
presenting the first dynamically customized content to the first user in response to the first user scanning the customized content code of the shipping label; and
presenting second dynamically customized content to a second user in response to the second user scanning the customized content code of the shipping label, wherein the second dynamically customized content is different customized content than the first dynamically customized content.

18. The one or more computer storage devices of claim 15, wherein the dynamically customized content is first dynamically customized content, and wherein the operations further comprise:
presenting the first dynamically customized content to the user in response to the user scanning the customized content code at a first time; and
presenting second dynamically customized content to the user in response to the user scanning the customized content code at a second time, wherein the first dynamically customized content is different customized content than the second dynamically customized content.

19. The one or more computer storage devices of claim 15, wherein the operations further comprise:
analyzing the package-related data by a machine learning component; and
generating a plurality of customized content predicted to be of interest to the user; and
selecting the customized content from the predicted plurality of content, the selected customized content including a promotion having a highest predicted likelihood of being utilized by the user.

20. The one or more computer storage devices of claim 15, wherein the operations further comprise:
authenticating the user using credential associated with the user; and
providing access to the customized content linked to the customized content code in response to successful authentication of the user, wherein the user is denied access to the customized content in response to a failure to authenticate the user.
